(19) United States
(12) Patent Application Publication
(10) Pub. No.: US 2011/0016238 A1
(43) Pub. Date: Jan. 20, 2011

(54) Data Access Apparatus

(75) Inventor: Takahiro MIOMO, Higashiosaka-shi (JP)

Correspondence Address: NOVAK DRUCE + QUIGG LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/837,973

(22) Filed: Jul. 16, 2010

(30) Foreign Application Priority Data
Jul. 17, 2009 (JP) 2009-168391

(51) Int. Cl. G06F 3/00

(52) U.S. Cl. 710/19

(57) ABSTRACT

A data access apparatus includes a detector detects a unit region in a vacant state, out of a plurality of unit regions forming a data recording region, by referring to a plurality of parameter values respectively corresponding to the plurality of unit regions. A determiner determines whether or not a data value of the unit region detected by the detector indicates a predetermined value when the data recording region is a region in which there is a restriction on the number of recording instances. A permitter permits an access process to the data recording region corresponding to an affirmative determined result of the determiner. A first changer changes the parameter value corresponding to the unit region detected by the detector, out of the plurality of parameter values, corresponding to a negative determined result of the determiner. A restarter restarts the detector after the change process of the first changer.

### CROSS REFERENCE OF RELATED APPLICATION

The disclosure of Japanese Patent Application No. 2009-168391, which was filed on Jul. 17, 2009, is incorporated herein by reference.

### BACKGROUND OF THE INVENTION ION

1. Field of the Invention

The present invention relates to a data access apparatus. More particularly, the present invention relates to a data access apparatus which refers to a plurality of parameter values respectively corresponding to a plurality of unit regions forming a data recording region so as to control an access process to the data recording region.

2. Description of the Related Art

According to one example of this type of apparatus, a vacant-region list is created based on an FAT recorded on a recording medium. A vacant region of a recording destination is determined with reference to the created vacant-region list, and compressed image data is recorded into the determined vacant region. When the recording is successful, the FAT is updated, and when a recording error is generated, a message is displayed on a monitor. When a set key is operated for the displayed message, a write protection is applied to the recording medium. The applying the write protection to the recording medium when the recording error is generated leads to avoiding of a phenomenon in which the recording error is generated at each time the recording is attempted. Thereby, an operability is improved.

However, in the above-described apparatus, once the recording error is generated, a subsequent recording is not possible, and thus, a utilization efficiency of the recording medium is decreased.

### SUMMARY OF THE INVENTION

A data access apparatus according to the present invention comprises: a detector which detects a unit region in a vacant state, out of a plurality of unit regions forming a data recording region, by referring to a plurality of parameter values respectively corresponding to the plurality of unit regions; a determiner which determines whether or not a data value of the unit region detected by the detector indicates a predetermined value when the data recording region is a region in which there is a restriction on the number of recording instances; a permitter which permits an access process to the data recording region, corresponding to an affirmative determined result of the determiner; a first changer which changes, corresponding to a negative determined result of the determiner, the parameter value corresponding to the unit region detected by the detector, out of the plurality of parameter values; and a restarter which restarts the detector after the change process of the first changer.

A data access control program product executed by a processor of a data access apparatus comprises: a detecting step of detecting a unit region in a vacant state, out of a plurality of unit regions forming a data recording region, by referring to a plurality of parameter values respectively corresponding to the plurality of unit regions; a determining step of determining whether or not a data value of the unit region detected by the detecting step indicates a predetermined value when the data recording region is a region in which there is a restriction on the number of recording instances; a permitting step of permitting an access process to the data recording region, corresponding to an affirmative determined result of the determining step; a changing step of changing, corresponding to a negative determined result of the determining step, the parameter value corresponding to the unit region detected by the detecting step, out of the plurality of parameter values; and a restarting step of restarting the detecting step after the change process of the changing step.

A data access control method executed by a data access apparatus comprises: a detecting step of detecting a unit region in a vacant state, out of a plurality of unit regions forming a data recording region, by referring to a plurality of parameter values respectively corresponding to the plurality of unit regions; a determining step of determining whether or not a data value of the unit region detected by the detecting step indicates a predetermined value when the data recording region is a region in which there is a restriction on the number of recording instances; a permitting step of permitting an access process to the data recording region, corresponding to an affirmative determined result of the determining step; a changing step of changing, corresponding to a negative determined result of the determining step, the parameter value corresponding to the unit region detected by the detecting step, out of the plurality of parameter values; and a restarting step of restarting the detecting step after the change process of the changing step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a recording state of a recording medium;

FIG. 4(A) is an illustrative view showing one example of a description of a directory entry;

FIG. 4(B) is an illustrative view showing one example of a description of an FAT;

FIG. 4(C) is an illustrative view showing one example of a description of a data area;

FIG. 5(A) is an illustrative view showing another example of the description of the directory entry;

FIG. 5(B) is an illustrative view showing another example of the description of the FAT;

FIG. 5(C) is an illustrative view showing another example of the description of the data area;

FIG. 6(A) is an illustrative view showing still another example of the description of the directory entry;

FIG. 6(B) is an illustrative view showing still another example of the description of the FAT;

FIG. 6(C) is an illustrative view showing still another example of the description of the data area;

FIG. 7(A) is an illustrative view showing yet another example of the description of the directory entry;

FIG. 7(B) is an illustrative view showing yet another example of the description of the FAT;

FIG. 7(C) is an illustrative view showing yet another example of the description of the data area;

FIG. 8 is a flowchart showing one portion of behavior of a CPU applied to the embodiment in FIG. 2;

FIG. 9 is a flowchart showing another portion of the behavior of the CPU applied to the embodiment in FIG. 2;

FIG. 10 is a flowchart showing still another portion of the behavior of the CPU applied to the embodiment in FIG. 2;

FIG. 11 is a flowchart showing yet another portion of the behavior of the CPU applied to the embodiment in FIG. 2; and

FIG. 12 is a flowchart showing a further portion of the behavior of the CPU applied to the embodiment in FIG. 2.

### DETAILED DESCRIPTION OF THE PREFERRED EMBODIMENTS

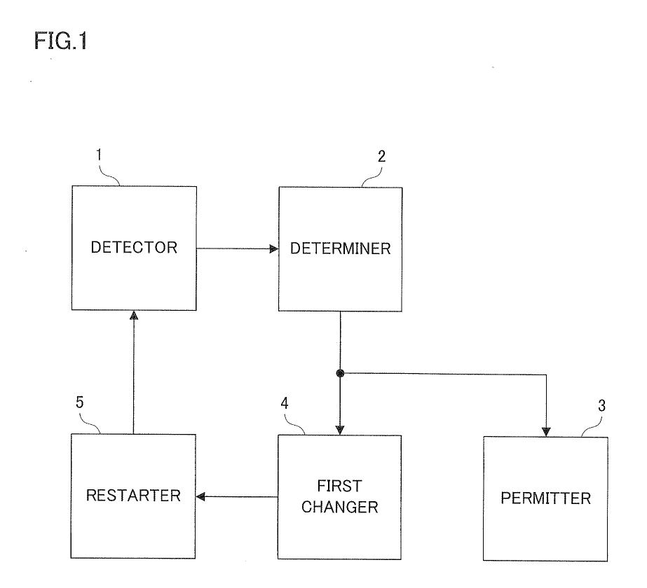

With reference to FIG. 1, a data access apparatus according to one embodiment of the present invention is basically configured as follows: A detector 1 detects a unit region in a vacant state, out of a plurality of unit regions forming a data recording region, by referring to a plurality of parameter values respectively corresponding to the plurality of unit regions. A determiner 2 determines whether or not a data value of the unit region detected by the detector 1 indicates a predetermined value when the data recording region is a region in which there is a restriction on the number of recording instances. A permitter 3 permits an access process to the data recording region corresponding to an affirmative determined result of the determiner 2. A first changer 4 changes the parameter value corresponding to the unit region detected by the detector 1, out of the plurality of parameter values, corresponding to a negative determined result of the determiner 2. A restarter 5 restarts the detector 1 after the change process of the first changer 4.

When there is the restriction on the number of recording instances to the data recording region, if the data value of the unit region detected assuming that the unit region is in the vacant state is the predetermined value, then the access process to the data recording region is permitted.

On the other hand, if the data value of the unit region detected as being in the vacant state is different from the predetermined value, then the parameter value corresponding to the detected unit region is changed and the process for detecting the unit region in the vacant state is executed again.

By executing the change process of the parameter value, a corresponding relationship between the parameter value and the data value in each unit region is established. The access process is permitted after the establishment of the corresponding relationship. Thereby, a recording defect resulting from a problematic corresponding relationship between the parameter value and the data value is solved, and thus, a utilization efficiency of a recording medium is improved.

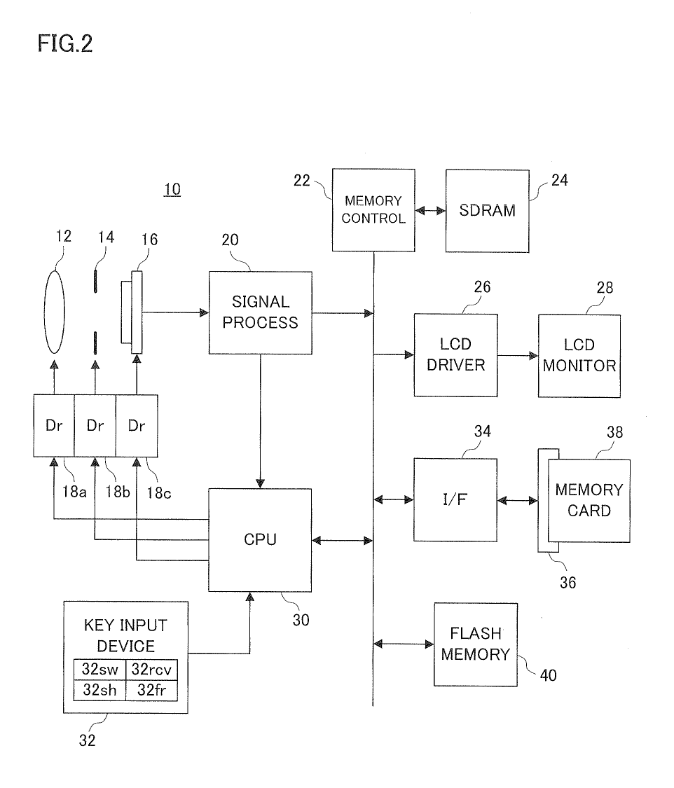

With reference to FIG. 2, a digital camera 10 according to this embodiment includes a focus lens 12 and an aperture unit 14 respectively driven by drivers 18a and 18b. An optical image of an object scene that undergoes these components enters, with irradiation, an imaging surface of an imager 16, and is subjected to a photoelectric conversion.

If a camera mode is selected by a mode selector switch 32sw, then a CPU 30 commands a driver 18c to repeat an exposure procedure and an electric-charge reading-out procedure in order to execute a moving-image fetching process under an imaging task. In response to a vertical synchronization signal Vsync that is cyclically generated, the driver 18c exposes the imaging surface of the imager 16 and reads out electric charges produced on the imaging surface in a raster scanning manner. From the imager 16, raw image data based on the read-out electric charges is cyclically outputted.

A signal processing circuit 20 performs processes, such as white balance adjustment, color separation, and YUV conversion, on the raw image data outputted from the imager 16, and writes YIN formatted-image data, which is produced as a result of these processes, into an SDRAM 24. An LCD driver 26 repeatedly reads out the image data accommodated in the SDRAM 24 through a memory control circuit 22, and drives an LCD monitor 28 based on the read-out image data. As a result, a moving image representing an object scene is displayed on a monitor screen.

Out of the image data produced by the signal processing circuit 20, Y data is applied also to the CPU 30. The CPU 30 performs a simple AE process on the applied Y data so as to calculate an appropriate EV value. An aperture amount and an exposure time defining the calculated appropriate EV value are set to the drivers 18b and 18c, respectively, and as a result, a brightness of the moving image is moderately adjusted.

When a shutter button 32sh is half-depressed, the CPU 30 performs a strict AE process on the Y data applied from the signal processing circuit 20 so as to calculate an optimal EV value. Similarly to the above-described case, an aperture amount and an exposure time defining the calculated optimal EV value are set to the drivers 18b and 18c, respectively. As a result, the brightness of the moving image is adjusted strictly. Moreover, the CPU 30 performs an AF process on a high-frequency component of the Y data applied from the signal processing circuit 20. Thereby, the focus lens 12 is placed at a focal point, and thus, a sharpness of the moving image is improved.

When the shutter button 32sh is fully depressed, the CPU 30 commands an I/F 34 to execute a recording process. The I/F 34 reads out one frame of image data representing the object scene at a time point at which the shutter button 32sh is operated, from the SDRM 24 through the memory control circuit 22, and records an image file including the read-out image data into a data area of a memory card 38.

Upon completion of the recording of the image file, the CPU 30 updates a directory entry and an FAT described later. The image file recorded in the data area is managed by the directory entry and the FAT. It is noted that the memory card 38 is removable and becomes accessible by the I/F 34 when the memory card 38 is attached to a slot 36.

When a reproduction mode is selected by the mode selector switch 32sw, the image file is reproduced under a reproduction task. The CPU 30 detects a latest image file from the memory card 38 by referring to the directory entry and the FAT, and commands the OF 34 and the LCD driver 26 to execute a reproduction process in which the detected image file is noticed. The I/F 34 reads out the image data from a designated image file, and writes the read-out image data into the SDRAM 24 through the memory control circuit 22.

An LCD driver 26 reads out the image data accommodated in the SDRAM 24, through the memory control circuit 22, and drives the LCD monitor 28 based on the read-out image data As a result, a still image based on the image data of the designated image file is displayed on the LCD monitor 28.

When a forward/return button 32fw of a key input device 32 is operated, the CPU 30 refers to the directory entry and the FAT so as to detect a succeeding image file or a preceding image file from the memory card 38. The detected image file is subjected to the reproduction process similar to that described above.

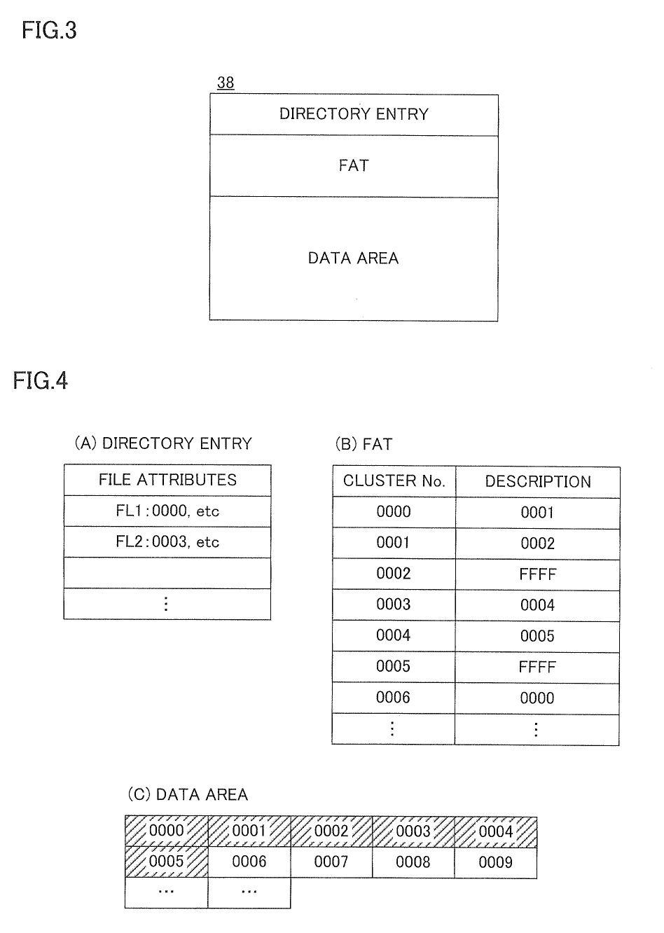

With reference to FIG. 3, the memory card 38 adopts an FAT file system, and has, besides a data area divided into a plurality of clusters, areas in which to record the directory entry and the FAT. The directory entry manages file attributes, such as a file name, a file size, a cluster number of a head cluster in which to record a file, and a recording date, for each image file recorded in the data area. Moreover, the FAT has a plurality of columns respectively corresponding to the plurality of clusters forming the data area, and manages a link state of one or at least two clusters in which to record a common image file.

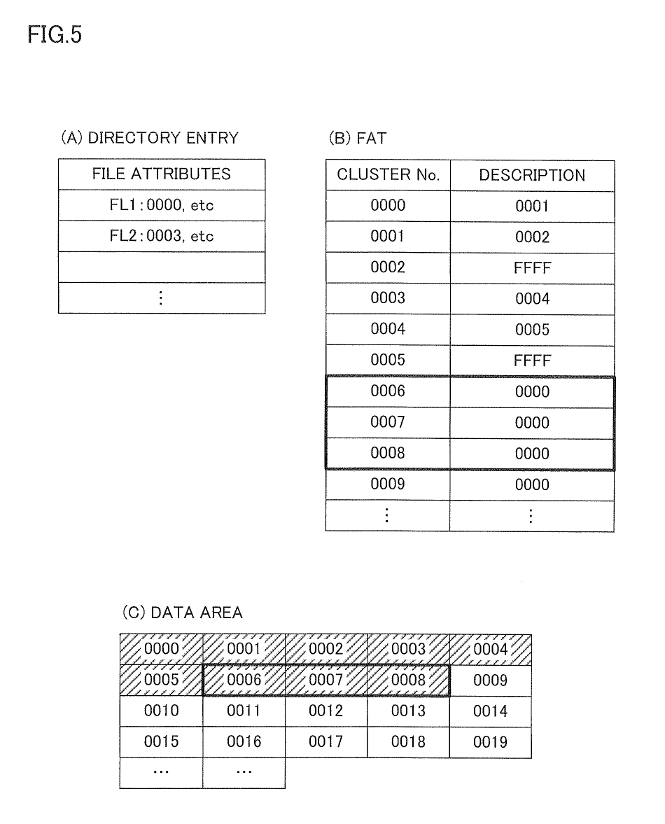

With reference to FIG. 4(A) to FIG. 4(C), if an image file FL1 is recorded in clusters of which the cluster numbers are “0000” to “0002”, and an image file FL2 is recorded in clusters of which the cluster numbers are “0003” to “0006”, the cluster number “0000” is described in the directory entry corresponding to the image file FL1 and the cluster number “0003” is described in the directory entry corresponding to the image file FL2.

In the FAT, “0001” is described corresponding to the cluster number “0000”, “0002” is described corresponding to the cluster number “0001′”, and “FFFF” is described corresponding to the cluster number “0002”. Also, in the FAT, “0004” is described corresponding to the cluster number “0003”, “0005” is described corresponding to the cluster number “0004”, and “FFFF” is described corresponding to the cluster number “0005”.

When the image file is newly recorded in the data area in this state, the directory entry and the FAT also are updated corresponding thereto. However, the process for recording the image file is executed on the memory card 38 while the process for updating the directory entry and the FAT is executed on the SDRAM 24. That is, the directory entry and the FAT are duplicated onto the SDRAM 24 in response to application of a power source, and the updating process is executed on the directory entry and the FAT duplicated on the SDRAM 24.

Thus, if the power source is forcedly shut off after the image file has been recorded and before the directory entry and the FAT on the SDRAM 24 are overwritten on the memory card 38, then there arises a problem in the corresponding relationship between the image file and the description of directory entry/FAT.

For example, with reference to FIG. 5(A) to FIG. 5(C), if the power source is shut off before the completion of overwriting the directory entry and the FAT even though an image file FL3 is newly recorded in clusters of which the cluster numbers are “0006” to “0008”, then there does not exist the attribute of the image file FL3 in the directory entry of the memory card 38 and the description of the FAT on the memory card 38 indicates a vacant state (=0000) corresponding to cluster numbers “0006” to “0008”.

Then, in the description of the directory entry and the FAT duplicated on the SDRAM 24 in response to a subsequent application of the power source, the cluster of which the cluster number is “0006” is regarded as a head cluster in the vacant state.

Herein, if the memory card 38 is a card that imposes a restriction on the number of recording instances into the data area, such as a Write Once Read Many (WORM) card, then recording into the cluster of which the cluster number is “0006” is forbidden. That is, if the WORM card is adopted as the memory card 38, then data-writing onto the memory card 38 is disabled after there occurs the problem in the corresponding relationship between the image file and the directory entry/FAT. Thereby, the utilization efficiency of the memory card 38 is deteriorated.

Therefore, in this embodiment, when the power source is applied, following processes are executed under a card control task.

Firstly, the FAT and the directory entry are duplicated from the memory card 38 into the SDRAM 24, and the head cluster in the vacant state in the data area is detected by referring to the duplicated FAT and directory entry.

If the memory card 38 is a card different from the WORM card or a data value of the cluster detected as being in the vacant state is “0000”, then access to the memory card 38 is permitted.

On the other hand, if the memory card 38 is WORM card and the data value of the cluster detected as being in the vacant state is different from “0000”, then an operator is notified of a card error. When a recovery button 32rcv on the key input device 32 is operated in response to the notification of the card error, the description of the FAT corresponding to the cluster detected as being in the vacant state is changed to “FFFF”.

Subsequently, a next cluster is designated, and it is determined whether or not the data value of the designated cluster is “0000”. If the data value is different from “0000”, then the description of the FAT corresponding to the designated cluster is changed to “FFFF”. A process for designating the next cluster and a process for changing the description of the FAT like these are repeated until the cluster in which the data value indicates “0000” is discovered. When the cluster in which the data value indicates “0000” is discovered, the operator is notified of a recovery completion. The process for detecting the head cluster in the vacant state by referring to the FAT and the directory entry is executed again after the notification of the recovery completion.

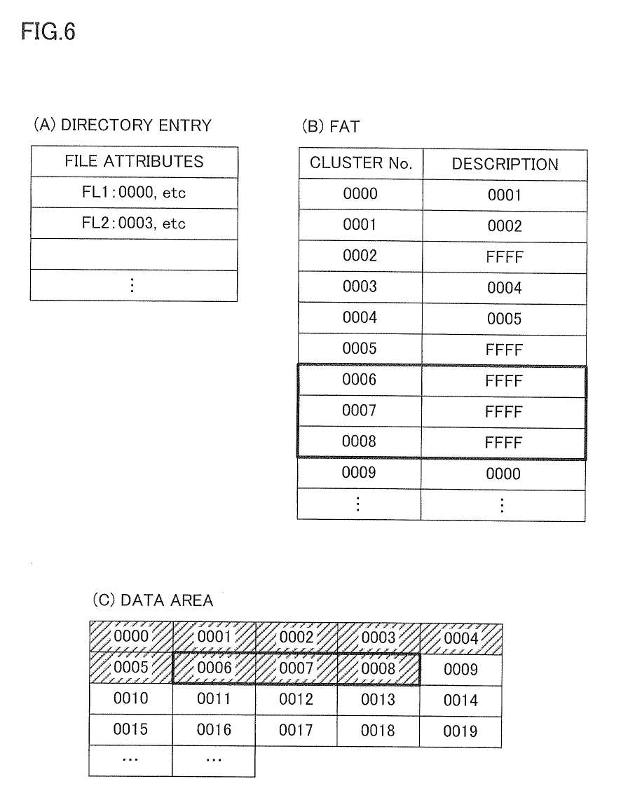

Therefore, if the power source is applied in a state in which the WORM card in states shown in FIG. 5(A) to FIG. 5(C) is attached, then the description of the FAT corresponding to the cluster numbers “0006” to “0008” is changed from “0000” to “FFFF”. That is, the state of the WORM card is transitioned from the states in FIG. 5(A) to FIG. 5(C) to those in FIG. 6(A) to FIG. 6(C). Upon completion of the process for changing the description of the FAT, the cluster of which the cluster number is “0009” is detected as the head cluster in the vacant state, and the access to the WORM card is permitted.

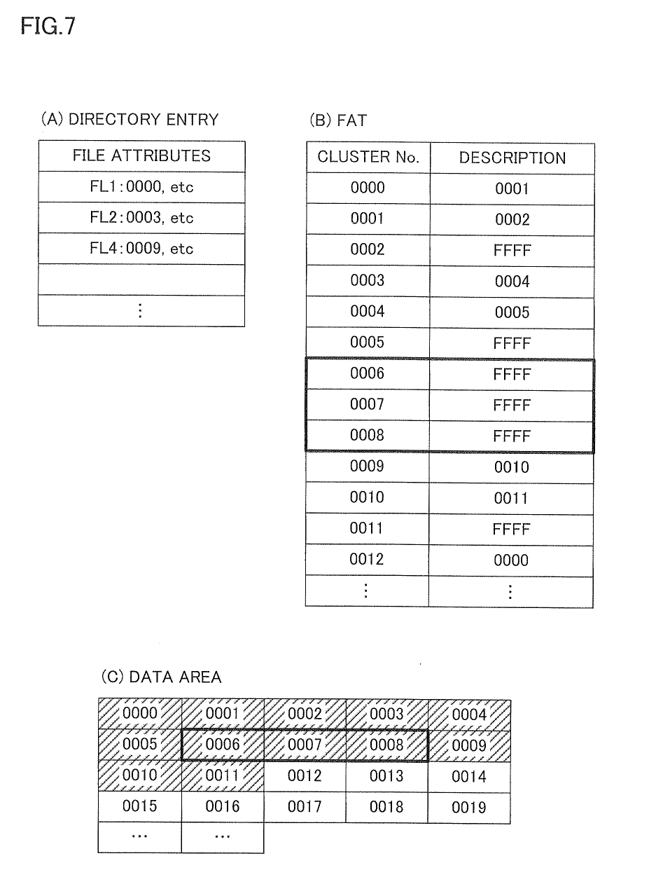

If an image file FL4 is newly recorded in clusters of which the cluster numbers are “0009” to “0011”, then the directory entry and the FAT corresponding thereto are updated. In the directory entry, the cluster number “0009” is described corresponding to the image file FL4. Also, in the FAT, “0010” is described corresponding to the cluster number “0009”, “0011” is described corresponding to the cluster number “0010”, and “FFFF” is described corresponding to the cluster number “0011”. As a result, the state of the memory card 38 is transitioned from the states in FIG. 6(A) to FIG. 6(C) to those in FIG. 7(A) to FIG. 7(C).

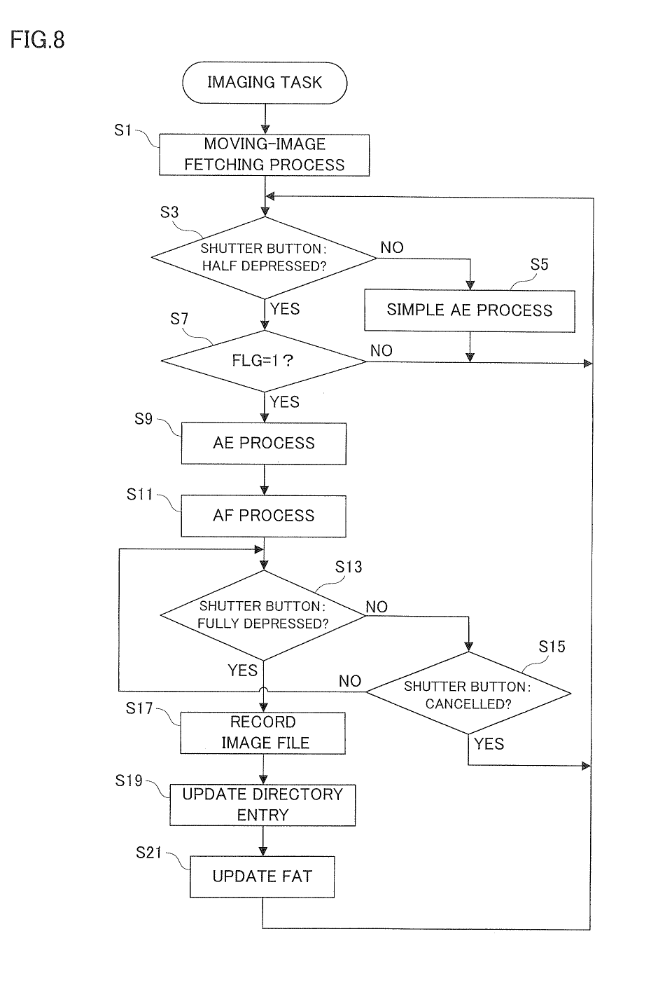

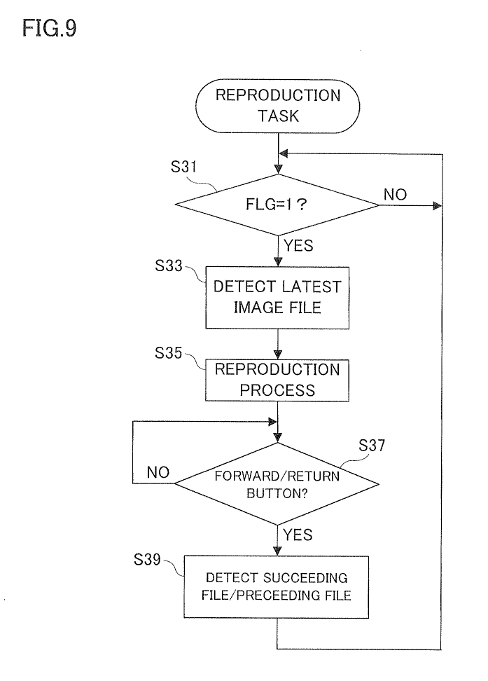

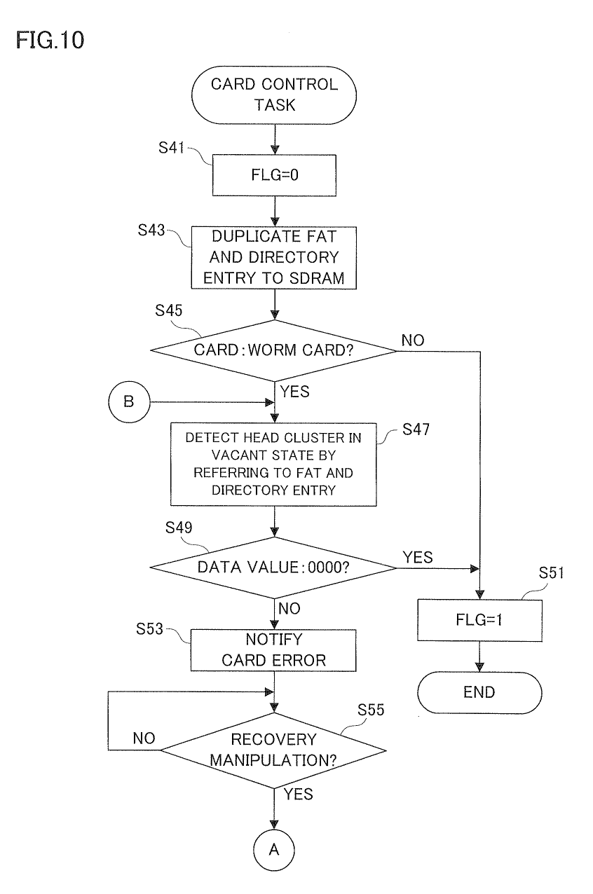

The CPU 30 executes an imaging task shown in FIG. 8 when the camera mode is selected, and executes a reproduction task shown in FIG. 9 when the reproduction mode is selected. Moreover, the CPU 30 executes the card control task shown in FIG. 10 to FIG. 12 in response to the application of the power source, irrespective of the modes. It is noted that control programs corresponding to these tasks are stored in a flash memory 40.

With reference to FIG. 8, in a step S1 , the moving-image fetching process is firstly executed. As a result, the moving image representing the object scene is displayed on the LCD monitor 28. In a subsequent step S3, it is determined whether or not the shutter button 32sh is half-depressed, and as long as a determined result is NO, a simple AE process in a step S5 is repeated. As a result, the brightness of the moving image is adjusted moderately.

When the shutter button 32sh is half-depressed, it is determined in a step S7 whether or not a flag FLG is “1”. The flag FLG is a flag for identifying permission/prohibition of the access to the memory card 38, and FLG=0 indicates the “prohibition” while FLG=1 indicates the “permission”. When the flag FLG is “0”, the process returns to the step S3, and when the flag FLG is “1”, the process advances to a step S9. It is noted that a value of the flag FLG is controlled under the card control task.

In a step S9, the AE process is executed, and in a step S11, the AF process is executed. Thereby, the brightness and the focus of the moving image are strictly adjusted. In a step S13, it is determined whether or not the shutter button 32sh is fully depressed. In a step S15, it is determined whether or not the operation of the shutter button 32sh is canceled. When YES is determined in the step S13, the process advances to a step S17, and when YES is determined in the step S15, the process returns to the step S3.

In a step S17, the I/F 34 is commanded to execute the recording process. As a result, the one frame of the image data representing the object scene at a time point at which the shutter button 32sh is operated is recorded, as the image file, in the data area of the memory card 38. In a step

S19, the directory entry duplicated onto the SDRAM 24 is updated. In a step S21, the FAT duplicated onto the SDRAM 24 is updated. Upon completion of the process in the step S21, the process returns to the step S3.

With reference to FIG. 9, it is determined in a step S31 whether or not the flag FLG is “1”. When a determined result is updated from NO to YES, the process advances to a step S33 so as to detect the latest image file from the memory card 38 by referring to the directory entry and the FAT. In a step S35, the reproduction process in which the designated image file is noticed is executed. As a result, the still image that is based on the image data of the designated image file is displayed on the LCD monitor 28. In a step S37, it is determined whether or not the forward/return button 32fr has been operated. When a determined result is updated from NO to YES, the process advances to a step S39 so as to detect the succeeding image file or the preceding image file by referring to the directory entry and the FAT. Upon completion of the process in the step S39, the process returns to the step S33. With reference to FIG. 10, in a step S41, the flag FLG is set to “0”, and in a step S43, the FAT and the directory entry are duplicated from the memory card 38 to the SDRAM 24. In a step S45, it is determined whether or not the memory card 38 is the WORM card. When a determined result is NO, the flag FLG is set to “1” in a step S51, and the process is ended. When the determined result is YES, the process advances to a step S47 so as to detect the head cluster in the vacant state, out of the plurality of clusters forming the data area by referring to the duplicated FAT and directory entry.

In a step S49, it is determined whether or not the data value of the detected cluster indicates “0000”. When a determined result is YES, the flag FLG is set to “1” in a step S51, and the process is ended. When the determined result is NO, the card error is notified in a step S53, and it is determined in a step S55 whether or not the recovery button 32rcv is operated.

When a determined result in the step S55 is updated from NO to YES, the process advances to a step S57 so as to change the description of the FAT corresponding to the cluster detected in the step S47 to “FFFF”. In a step S59, the next cluster is designated. In a step S61, it is determined whether or not the data value of the designated cluster is “0000”. When a determined result is NO, the description of the FAT corresponding to the designated cluster is changed to “FFFF” in a step S63, and thereafter, the process returns to the step S59. When the determined result is YES, the operator is notified of the recovery completion in a step S65, and thereafter, the process returns to the step S47.

As can be seen from the above-described explanation, the CPU 30 detects the cluster in the vacant state, out of the plurality of clusters forming the data area by referring to the description of the FAT (S47). Moreover, when the memory card 38 is the WORM card, the CPU 30 determines whether or not the data value of the cluster detected as being in the vacant state indicates “0000” (S45, S49). The CPU 30 permits the access process to the data area, corresponding to the affirmative determined result (S51), and changes the description of the FAT corresponding the cluster detected as being in the vacant state, corresponding to the negative determined result (S57 to S63). When the description of the FAT is changed, the CPU 30 executes again the process for detecting the cluster in the vacant state (S65).

Thus, when the memory card 38 is the WORM card, if the data value of the cluster detected as being in the vacant state indicates “0000”, then the access process to the data area is permitted. On the other hand, if the data value of the cluster detected as being in the vacant state is different from “0000”, then the description of the FAT corresponding to the detected cluster is changed and the process for detecting the cluster in the vacant state is executed again.

As a result of the process for changing the description of the FAT, the corresponding relationship between the description of the FAT and the data value in each cluster is established. The access process is permitted after the establishment of the corresponding relationship. Thereby, a recording defect resulting from a problematic corresponding relationship between the description of the FAT and the data value is solved, and thus, the utilization efficiency of the WORM card is improved.

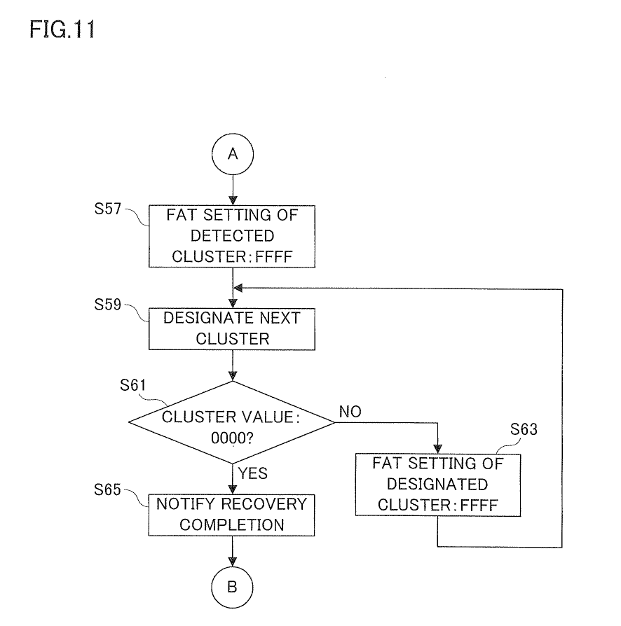

It is noted that in this embodiment, when the problematic corresponding relationship between the description of the FAT and the data value is detected from the WORM card, the data value of the cluster in which the corresponding relationship is problematic is changed by each one cluster, and at a time point at which the cluster of which the data value indicates “0000” is discovered, the change process is ended (see the steps S57 to S63 in FIG. 11).

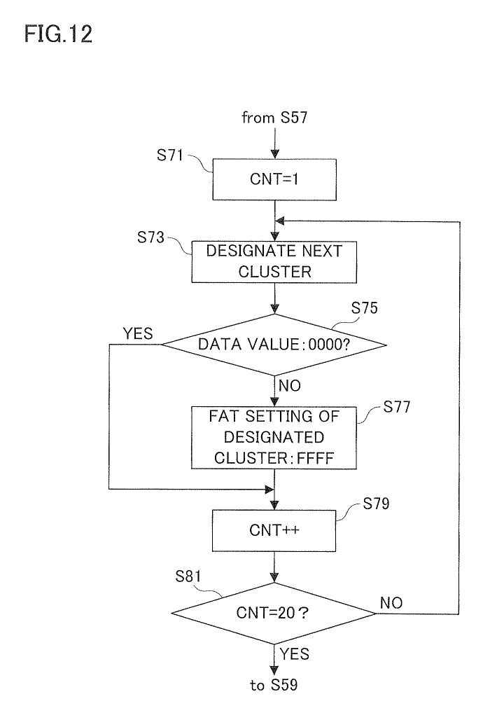

However, depending on an operation state when the power source is forcedly shut off, there is a possibility that the cluster in which the corresponding relationship is problematic is intermittently distributed. In consideration of such a concern, it is necessary to execute a process shown in FIG. 12 between the steps S57 and S59 shown in FIG. 11.

With reference to FIG. 12, a variant CNT is set to “1” in a step S71, and the next cluster in the vacant state is designated in a step S73. In a step S75, it is determined whether or not the data value of the designated cluster is “0000”. When a determined result is YES, the process directly advances to a step S79 while when the determined result is NO, the process advances to the step S79 after changing the description of the FAT corresponding to the designated cluster to “FFFF” in a step S77. In a step S79, the variant CNT is incremented. In a step S81, it is determined whether or not the variant CNT reaches “20”. When a determined result is NO, the process returns to the step S73 while when the determined result is YES, the process advances to a step S59.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data access apparatus, comprising:
a detector which detects a unit region in a vacant state, out of a plurality of unit regions forming a data recording region, by referring to a plurality of parameter values respectively corresponding to the plurality of unit regions;
a determiner which determines whether or not a data value of the unit region detected by said detector indicates a predetermined value when the data recording region is a region in which there is a restriction on the number of recording instances;
a permitter which permits an access process to the data recording region, corresponding to an affirmative determined result of said determiner;
a first changer which changes, corresponding to a negative determined result of said determiner, the parameter value corresponding to the unit region detected by said detector, out of the plurality of parameter values; and
a restarter which restarts said detector after the change process of said first changer.

2. A data access apparatus according to claim 1, wherein said detector detects a head unit region in the vacant state, said data access apparatus further comprising a second changer which changes the parameter value corresponding to another unit region in the vacant state, in association with the change process of said first changer.

3. A data access apparatus according to claim 1, further comprising:
a recorder which records desired data into the unit region in the vacant state after a permitting process of said permitter; and
a third changer which changes a parameter value corresponding to a unit region noticed by said recorder.

4. A data access apparatus according to claim 1, further comprising a reproducer which reproduces the data recorded into the data recording region after the permitting process of said permitter.

5. A data access apparatus according to claim 1, further comprising:
a generator which generates a notification when the determined result of said determiner is negative; and
a starter which starts said first changer in response to a predetermined operation toward the notification generated by said generator.

6. A data access control program product executed by a processor of a data access apparatus, comprising:
a detecting step of detecting a unit region in a vacant state, out of a plurality of unit regions forming a data recording region, by referring to a plurality of parameter values respectively corresponding to the plurality of unit regions;
a determining step of determining whether or not a data value of the unit region detected by said detecting step indicates a predetermined value when the data recording region is a region in which there is a restriction on the number of recording instances;
a permitting step of permitting an access process to the data recording region, corresponding to an affirmative determined result of said determining step;
a changing step of changing, corresponding to a negative determined result of said determining step, the parameter value corresponding to the unit region detected by said detecting step, out of the plurality of parameter values; and
a restarting step of restarting said detecting step after the change process of said changing step.

7. A data access control method executed by a data access apparatus, comprising:
a detecting step of detecting a unit region in a vacant state, out of a plurality of unit regions forming a data recording region, by referring to a plurality of parameter values respectively corresponding to the plurality of unit regions;
a determining step of determining whether or not a data value of the unit region detected by said detecting step indicates a predetermined value when the data recording region is a region in which there is a restriction on the number of recording instances;
a permitting step of permitting an access process to the data recording region, corresponding to an affirmative determined result of said determining step;
a changing step of changing, corresponding to a negative determined result of said determining step, the parameter value corresponding to the unit region detected by said detecting step, out of the plurality of parameter values; and
a restarting step of restarting said detecting step after the change process of said changing step.
